(19) United States
(12) Patent Application Publication
(10) Pub. No.: US 2015/0317973 A1
(43) Pub. Date: Nov. 5, 2015

(54) SYSTEMS AND METHODS FOR COORDINATING SPEECH RECOGNITION

(71) Applicant: GM Global Technology Operations LLC, Detroit, MI (US)

(72) Inventors: CODY R. HANSEN, SHELBY TOWNSHIP, MI (US); ROBERT A. HRABAK, WEST BLOOMFIELD, MI (US); TIMOTHY J. GROST, CLARKSTON, MI (US)

(73) Assignee: GM GLOBAL TECHNOLOGY OPERATIONS LLC, Detroit, MI (US)

(21) Appl. No.: 14/266,593

(22) Filed: Apr. 30, 2014

(51) Int. Cl. G10L 15/08; G10L 17/22; G10L 15/22

(52) U.S. Cl. CPC G10L 15/08; G10L 15/22; G10L 17/22

(57) ABSTRACT

Methods and systems are provided for coordinating recognition of a speech utterance between a speech system of a vehicle and a speech system of a user device. In one embodiment, a method includes: receiving the speech utterance from a user; performing speech recognition on the speech utterance to determine a topic of the speech utterance; determining whether the speech utterance was meant for the speech system of the vehicle or the speech system of the user device based on the topic of the speech utterance; and selectively providing the speech utterance to the speech system of the vehicle or the speech system of the user device based on the determination of whether the speech utterance was meant for the speech system of the vehicle or the speech system of the user device.

### TECHNICAL FIELD

The technical field generally relates to speech systems, and more particularly relates to methods and systems for coordinating speech recognition between speech systems of a vehicle and a user device.

### BACKGROUND

Vehicle speech systems perform, among other things, speech recognition based on speech uttered by occupants of a vehicle. The speech utterances typically include commands that communicate with or control one or more features of the vehicle.

In some instances, a vehicle may be in communication with with a user device that is in proximity to the vehicle, such as a smart phone or other device. The user device may include a speech system that performs, among other things, speech recognition based on speech uttered by users of the device. Such speech utterances typically include commands that communicate with or control one or more applications of the user device.

Accordingly, it is desirable to provide methods and systems for coordinating the recognition of speech commands uttered by occupants of a vehicle when a user device is in communication with the vehicle. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for coordinating recognition of a speech utterance between a speech system of a vehicle and a speech system of a user device. In one embodiment, a method includes: receiving the speech utterance from a user; performing speech recognition on the speech utterance to determine a topic of the speech utterance; determining whether the speech utterance was meant for the speech system of the vehicle or the speech system of the user device based on the topic of the speech utterance; and selectively providing the speech utterance to the speech system of the vehicle or the speech system of the user device based on the determination of whether the speech utterance was meant for the speech system of the vehicle or the speech system of the user device.

In another embodiment, a system includes a first module that receives the speech utterance from a user, and that performs speech recognition on the speech utterance to determine a topic of the speech utterance. The system further includes a second module that determines whether the speech utterance was meant for the speech system of the vehicle or the speech system of the user device based on the topic of the speech utterance, and that selectively provides the speech utterance to the speech system of the vehicle or the speech system of the user device based on the determination of whether the speech utterance was meant for the speech system of the vehicle or the speech system of the user device.

In another embodiment, a vehicle is provided. The vehicle includes a speech system, and a recognition coordinator module. The recognition coordinator module receives a speech utterance from a user of the vehicle, performs speech recognition on the speech utterance to determine a topic of the speech utterance, and determines whether the speech utterance was meant for the speech system of the vehicle or the speech system of the user device based on the topic of the speech utterance.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle and a user device, each including a speech system in accordance with various exemplary embodiments;

FIG. 2 is a dataflow diagram illustrating a recognition coordinator module of the speech system in accordance with various exemplary embodiments: and

FIGS. 3 and 4 are flowcharts illustrating speech methods in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

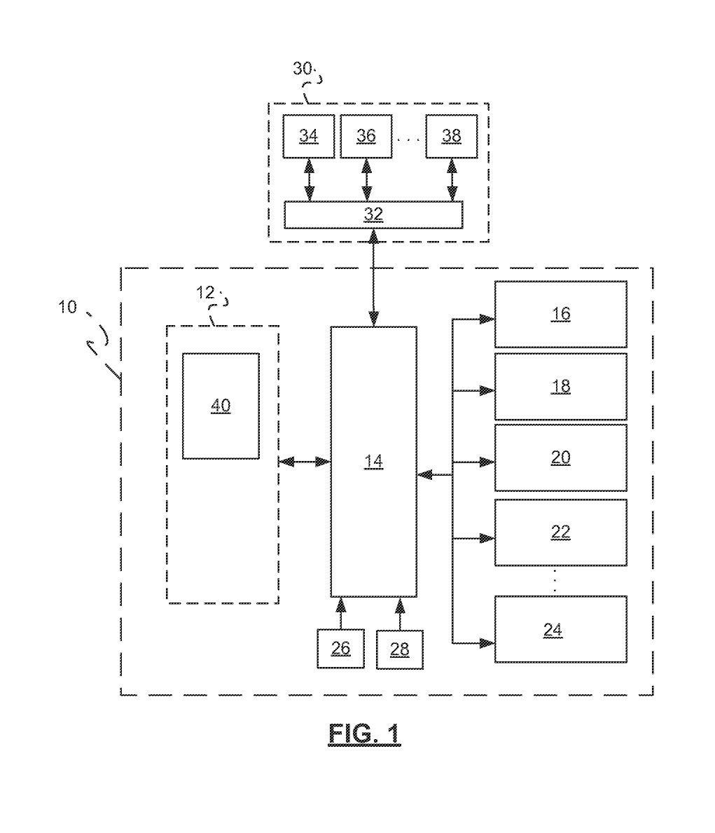

Referring now to FIG. 1, in accordance with exemplary embodiments of the subject matter described herein, a vehicle 10 is shown having a speech system 12 in accordance with various embodiments. In general, the speech system 12 of the vehicle 10 provides speech recognition, dialog management, and speech generation for one or more systems of the vehicle 10 through a human machine interface module (HMI) module 14. Such vehicle systems may include, for example, but are not limited to, a phone system 16, a navigation system 18, a media system 20, a telematics system 22, a network system 24, and any other vehicle system that may include a speech dependent application.

The HMI module 14 is configured to be operated by (or otherwise interface with) one or more users (e.g., a driver, passenger, etc.) through one or more user input devices. Such user input devices may include, for example, but are not limited to, a microphone 26, and an activation button 28. The microphone 26, for example, may be configured to record speech utterances made by a user. The activation button 28 may be configured to activate the recording by the microphone 26 and/or to indicate an intent of the recording. For example, the activation button 28, when depressed for a first period (e.g., a shorter period), sends a signal indicating to activate the recording by the microphone for a speech utterance that is intended for a vehicle system 16-24. In another example, the activation button 28, when depressed for a second period (e.g., a longer period), sends a signal indicating to activate the recording by the microphone 26 for a speech utterance that is intended for a non-vehicle system (e.g., an application of a user device, or other system as will be discussed in more detail below).

In various embodiments, one or more user devices 30 may be present within or nearby the vehicle 10 at any one time, and may be in communication with the vehicle 10 through the HMI module 14. For example, the user device 30 may be configured to communicate directly with the HMI module 14 or other component of the vehicle 10 through a suitable wired or wireless connection (e.g., Bluetooth, Wi-Fi, USB, etc.). The user device 30 may be, for example, a smart-phone, a tablet computer, a feature phone, or the like and may include a speech system 32. In general, the speech system 32 of the user device 30 provides speech recognition, dialog management, and speech generation for one or more applications of the user device 30. Such applications may include, for example, but are not limited to, a navigation application 34, a media application 36, a phone application 38, and/or and any other application that may include a speech dependent application.

The speech system 12 of the vehicle 10 is shown to include (or be associated with) a recognition coordinator module 40. The recognition coordinator module 40 coordinates a recognition of the speech utterance provided by the user based the signal indicating the intent of the recording. For example, when the signal indicates that the speech utterance is intended for use by an application of the user device 30, the recognition coordinator module 40 stores the speech utterance in an audio buffer for transmitting by the HMI module 14 to the user device 30. In another example, when the signal indicates that the speech utterance is intended for use by a vehicle system of the vehicle 10, the recognition coordinator module 40 first determines whether the speech utterance was really meant for use by an application of the user device 30, and if the speech utterance was really meant for use by an application of the user device 30, the recognition coordinator module 40 stores the speech utterance in an audio buffer for transmitting by the HMI module 14 to the user device 30. The speech system 32 of the user device 30 receives the audio buffer and processes the speech utterance. If, however, the speech utterance was not really meant for use by an application of the user device 30, the recognition coordinator module 40 processes the speech utterance with the speech system 12 of the vehicle 10.

In various embodiments, if the speech utterance was really meant for use by an application of the user device 30, the recognition coordinator module 40 determines a context of the speech utterance (e.g., a media context, a navigation context, a phone context, etc.) for transmitting with the audio buffer. The speech system 32 of the user device 30 receives the context and uses the context to provide improved recognition of the speech utterance.

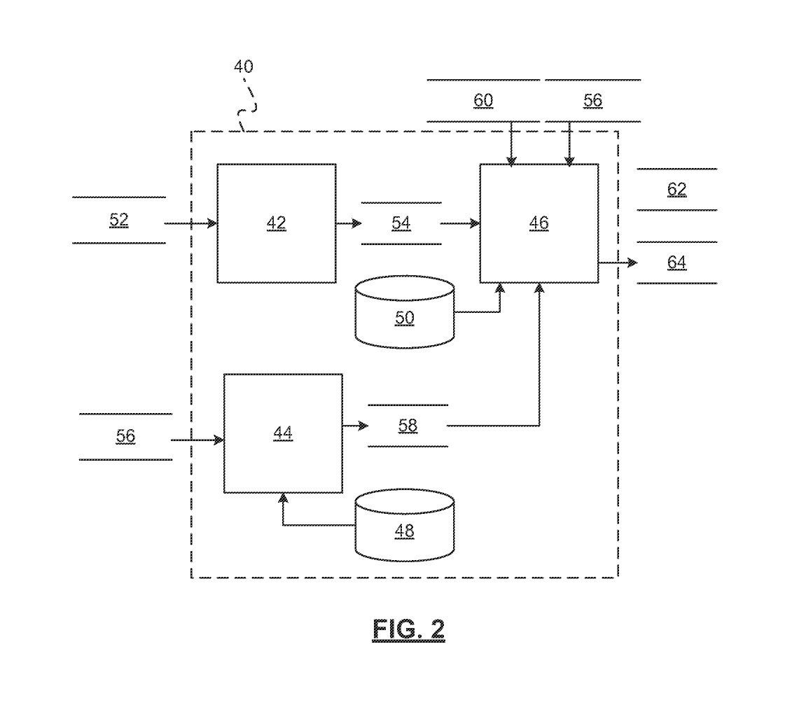

Referring now to FIG. 2 and with continued reference to FIG. 1, a dataflow diagram illustrates the recognition coordinator module 40 in accordance with various exemplary embodiments. As can be appreciated, various exemplary embodiments of the recognition coordinator module 40, according to the present disclosure, may include any number of sub-modules. In various exemplary embodiments, the sub-modules shown in FIG. 2 may be combined and/or further partitioned to coordinate the recognition of a speech utterance between the speech system 12 of the vehicle 10 and the speech system 32 of the user device 30. In various exemplary embodiments, the recognition coordinator module 40 includes an intent determination module 42, a topic determination module 44, a coordination module 46, a topics datastore 48, and a context datastore 50.

The intent determination module 42 receives as input data 52 from the signal indicating to activate the recording and indicating the intent of the speech utterance (e.g., as indicated by the user when depressing the activation button 28). Based on the data 52, the intent determination module 42 determines the intent 54 of the speech utterance to be for use by a vehicle system or for use by an application of a user device.

The topic determination module 44 receives as input a speech utterance 56 (e.g., based on a user speaking to the microphone 26 associated with the HMI module 14). The topic determination module 44 processes the speech utterance 56 to determine a topic 58 of the speech utterance 56 using one or more topic recognition methods. For example, the topic determination module 44 may determine a verb of the speech utterance 56 using one or more speech recognition techniques and may select a topic 58 based on an association of the verb with a particular topic stored in the topics datastore 48. As can be appreciated, this is merely an example and other methods may be used to determine the topic 58 of the speech utterance 56.

The coordination module 46 receives as input the intent 54 of the speech utterance, the topic 58 of the speech utterance, the speech utterance, and data 60 indicating whether a user device 30 is in communication with the vehicle 10. Based on the inputs, the coordination module 46 prepares the speech utterance 56 for processing by either the speech system 12 of the vehicle 10 or the speech system 32 of the user device 30. For example, if the data 60 indicates that a user device 30 is not in communication with the vehicle 10, the coordination module 46 provides the speech utterance 56 to the speech system 12 of the vehicle 10 for further processing.

If, however, the data 60 indicates that one or more user devices 30 are in communication with the vehicle 10, the coordination module 46 determines whether the intent 54 of the speech utterance is for use by the speech system 32 of the user device 30. If the intent 54 of the speech utterance is for use by the speech system 32 of the user device 30, the coordination module 46 stores the speech utterance 56 in an audio buffer 62 for transmitting to the speech system 32 of the user device 30 via the HMI module 14.

If, however, the intent 54 of the speech utterance is for use by the speech system 12 of the vehicle 10, the coordination module 46 determines whether the topic 58 of the speech utterance was really meant for use by the user device 30 (e.g., by comparing the topic with topics associated with a particular user device or a particular type of user device). If multiple user devices are provided, the coordination module 46 determines which of the user devices the topic is really meant for. If it is determined that the speech utterance is really meant for a particular user device, the coordination module 46 stores the speech utterance 56 in the audio buffer 62 for transmitting to the speech system 32 of the user device 30 via the HMI module 14.

In various embodiments, the coordination module 46 determines a context 64 of the speech utterance 56 based on the topic 58. For example, the coordination module 46 may select a context 64 based on an association of the topic 58 with a particular context stored in the context datastore 50. As can be appreciated, this is merely an example and other methods may be used to determine the context 64 of the speech utterance 56. The coordination module 46 stores the context for transmitting to the speech system 32 of the user device 30 via the HMI module 14.

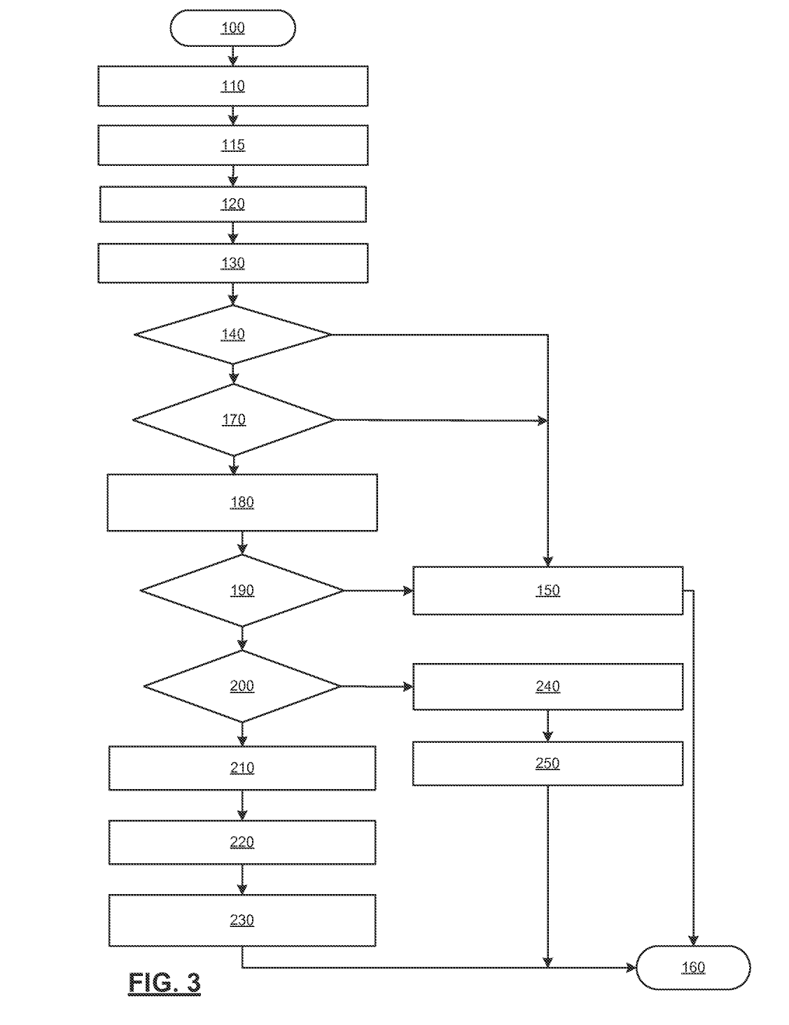

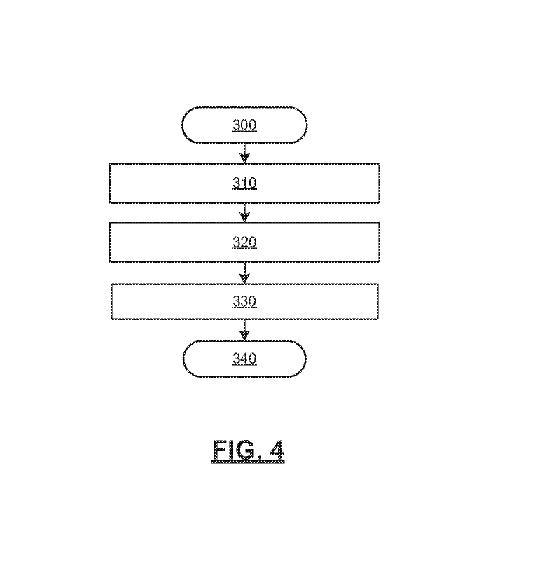

Referring now to FIGS. 3 and 4, and with continued reference to FIGS. 1 and 2, flowcharts illustrate speech methods that may be performed by the speech system 12 of the vehicle 10 having a recognition coordinator module 40 and the speech system 32 of the user device 30, in accordance with various exemplary embodiments. As can be appreciated in light of the disclosure, the order of operation within the methods is not limited to the sequential execution as illustrated in FIGS. 3 and 4, but may be performed in one or more varying orders as applicable and in accordance with the present disclosure. As can further be appreciated, one or more steps of the methods may be added or removed without altering the spirit of the methods.

With reference to FIG. 3, a speech method that may be performed by the speech system 12 of the vehicle 10 is shown in accordance with various exemplary embodiments. The method may begin at 100. The signal indicating to activate the recording of the speech is received at 110 (e.g., based on a user depressing the activation button 28 of the HMI module 14 for a first period of time (a short period)). The intent 54 of the speech utterance is determined to be “for use by a vehicle system” at 115. The speech utterance 56 is received at 120 (e.g., based on a user speaking to the microphone 26 associated with the HMI module 14). The topic 58 of the speech utterance 56 is identified using a topic recognition method at 130.

It is then determined whether a user device 30 is in communication with the vehicle 10 at 140. If a user device 30 is not in communication with the vehicle 10 at 140, the speech utterance 56 is provided to the speech system 12 of the vehicle 10 for further processing at 150 and the method may end at 160. If, however, one or more user devices 30 are in communication with the vehicle 10 at 140, it is determined whether the topic 58 of the speech utterance 56 is meant for use by a particular user device 30 at 170. In the case of multiple user devices 30 being in communication with the vehicle 10 at one time, it is determined which of the user devices 30 the topic 58 of the speech utterance 56 is meant for.

If it is determined that the topic 58 is not meant for a particular user device 30 at 170, the speech utterance 56 is provided to the speech system 12 of the vehicle 10 for further processing at 150 and the method may end at 160. If it is determined that the topic 58 is meant for a particular user device at 170, optionally, a dialog may be held with the user to confirm that the speech utterance was meant for the particular user device 30 at 180 and 190. If the user does not confirm the particular user device 30 at 190, the speech utterance 56 is provided to the speech system 12 of the vehicle 10 for further processing at 150 and the method may end at 160.

If, however, the user confirms the particular user device 30 at 190, it is determined whether the particular user device 30 is capable of accepting context information at 200. If the user device is capable of accepting the context information at 200, the context 64 is determined based on the topic 58 at 210 and the speech utterance 56 is stored in the audio buffer 62 at 220. The context 64 and the audio buffer 62 are communicated to the user device 30 (e.g., using the wired or wireless communication protocol) via the HMI module 14 at 230. Thereafter, the method may end at 160.

If, at 200, the user device 30 is not capable of accepting the context information, the speech utterance 56 is stored in an audio buffer 62 at 240 and the audio buffer 62 is communicated to the user device 30 (e.g., using the wired or wireless communication protocol) via the HMI module 14 at 250. Thereafter, the method may end at 160.

With reference to FIG. 4, a speech method that may be performed by the speech system 32 of the user device 30 is shown in accordance with various exemplary embodiments. The method may begin at 300. The user device 30 receives the audio buffer 62 or the audio buffer 62 and the context 64 at 310. The speech system 32 of the user device 30 then performs speech recognition on the speech utterance 56 of the audio buffer 62 at 320. If the context 64 is provided, the speech system 32 of the user device 30 performs speech recognition on the speech utterance 56 using the context 64. For example, if the context 64 indicates media, the speech recognition methods tailored to the media information of the media application 36 on the user device 30 are used to process the speech utterance 56. In another example, if the context 64 indicates navigation, the speech recognition methods tailored to the navigation information of the navigation application 34 on the user device 30 are used to process the speech utterance 56. Thereafter, at 330, the user device 30 may control a function of the user device 30 and/or may control a dialog with the user based on the results of the speech recognition and the method may end at 340.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for coordinating recognition of a speech utterance between a speech system of a vehicle and a speech system of a user device, comprising:
receiving the speech utterance from a user;
performing speech recognition on the speech utterance to determine a topic of the speech utterance;
determining whether the speech utterance was meant for the speech system of the vehicle or the speech system of the user device based on the topic of the speech utterance; and
selectively providing the speech utterance to the speech system of the vehicle or the speech system of the user device based on the determination of whether the speech utterance was meant for the speech system of the vehicle or the speech system of the user device.

2. The method of claim 1, further comprising:
determining that the user device is in communication with the vehicle; and
wherein the determining whether the speech utterance was meant for the speech system of the vehicle or the speech system of the user device is further based on the user device that is in communication with the vehicle.

3. The method of claim 2, further comprising:
determining that multiple user devices are in communication with the vehicle, and
wherein the determining whether the speech utterance was meant for the speech system of the vehicle or the speech system of the user device comprises determining whether the speech utterance was meant for the speech system of the vehicle or the speech system of a particular user device of the multiple user devices that are in communication with the vehicle.

4. The method of claim 1, further comprising:
determining a context of the speech utterance based on the topic; and
selectively providing the context of the speech utterance to the speech system of the vehicle or the speech system of the user device.

5. The method of claim 4, further comprising:
determining whether the user device is capable of accepting the context, and
wherein the selectively providing the context of the speech utterance to the speech system of the vehicle or the speech system of the user device is based on the determination of whether the user device is capable of processing the context.

6. The method of claim 1, further comprising:
receiving a signal to activate the vehicle speech recognition; and
determining an intent of use of the speech utterance based on the signal.

7. The method of claim 6, wherein the performing the speech recognition on the speech utterance to determine the topic of the speech utterance is based on the intent of use of the speech utterance.

8. The method of claim 6, wherein the determining whether the speech utterance was meant for the speech system of the vehicle or the speech system of the user device is based on the intent of use of the speech utterance.

9. The method of claim 1, wherein the receiving the speech utterance of the user is by the speech system of the vehicle, and wherein the selectively providing comprises providing the speech utterance to the speech system of the user device.

10. A system for coordinating recognition of a speech utterance between a speech system of a vehicle and a speech system of a user device, comprising:
a first module that receives the speech utterance from a user, and that performs speech recognition on the speech utterance to determine a topic of the speech utterance; and
a second module that determines whether the speech utterance was meant for the speech system of the vehicle or the speech system of the user device based on the topic of the speech utterance, and that selectively provides the speech utterance to the speech system of the vehicle or the speech system of the user device based on the determination of whether the speech utterance was meant for the speech system of the vehicle or the speech system of the user device.

11. The system of claim 10, wherein the second module determines that the user device is in communication with the vehicle, and determines whether the speech utterance was meant for the speech system of the vehicle or the speech system of the user device further based on the user device that is in communication with the vehicle.

12. The system of claim 11, wherein the second module determines that multiple user devices are in communication with the vehicle, and determines whether the speech utterance was meant for the speech system of the vehicle or the speech system of a particular user device of the multiple user devices that are in communication with the vehicle.

13. The system of claim 10, wherein the second module determines a context of the speech utterance based on the topic, and selectively provides the context of the speech utterance to the speech system of the vehicle or the speech system of the user device.

14. The system of claim 13, wherein the second module determines whether the user device is capable of accepting the context, and selectively provides the context of the speech utterance to the speech system of the vehicle or the speech system of the user device based on the determination of whether the user device is capable of accepting the context.

15. The system of claim 10, further comprising a third module that receives a signal to activate the vehicle speech recognition, and that determines an intent of use of the speech utterance based on the signal.

16. The system of claim 15, wherein the first module performs the speech recognition on the speech utterance to determine the topic of the speech utterance based on the intent of use of the speech utterance.

17. The system of claim 15, wherein the second module determines whether the speech utterance was meant for the speech system of the vehicle or the speech system of the user device based on the intent of use of the speech utterance.

18. The system of claim 10, wherein the first module receives the speech utterance of the user by the speech system of the vehicle, and wherein the second module provides the speech utterance to the speech system of the user device.

19. A vehicle, comprising:
a speech system; and
a recognition coordinator module that receives a speech utterance from a user of the vehicle, that performs speech recognition on the speech utterance to determine a topic of the speech utterance, and that determines whether the speech utterance was meant for the speech system of the vehicle or the speech system of the user device based on the topic of the speech utterance.

20. The vehicle of claim 19, wherein the recognition coordinator module determines a context of the speech utterance based on the topic, and selectively provides at least one of the speech utterance and the context to the speech system of the user device based on the determination of whether the speech utterance was meant for the speech system of the vehicle or the speech system of the user device.
